(19) United States
(12) Patent Application Publication
(10) Pub. No.: US 2007/0230506 A1
(43) Pub. Date: Oct. 4, 2007

(54) Method, device and system for transmitting very-long short message

(75) Inventor: Fengshao Zou, Shenzhen (CN)

Correspondence Address: Clifford J. Mass;Ladas & Parry LLP, 26 West 61 Street, New York, NY, 10023, US

(73) Assignee: HUAWEI TECHNOLOGIES CO., LTD.

(21) Appl. No.: 11/729,304

(22) Filed: Mar. 28, 2007

(30) Foreign Application Priority Data
Mar. 29, 2006 (CN) 200610034798.7

(51) Int. Cl. H04J 3/24; H04J 3/04

(52) U.S. Cl. 370/473; 370/535

(57) ABSTRACT

The embodiments of the present invention provide a method, a device and a system for transmitting a very-long short message, where when a sender determines that a very-long short message has a length exceeding a short message length allowed currently, the sender divides the very-long short message into a plurality of messages for transmission, the plurality of messages carrying parameters which indicate that the plurality of messages belong to the same very-long short message; and a receiver receives the plurality of messages, and combines the plurality of messages into the very-long short message according to the parameters.

### CROSS-REFERENCE TO RELATED APPLICATIONS

This application claims priority to Chinese Application No. 200610034798.7, filed with the Chinese Patent Office on Mar. 29, 2006 and entitled “METHOD, DEVICE AND SYSTEM FOR TRANSMITTING VERY-LONG SHORT MESSAGE IN CDMA CIRCUIT DOMAIN”, contents of which are incorporated herein by reference in its entirety.

### FIELD OF THE INVENTION

The present invention relates to a communication system, and more particularly to a method, device and system for transmitting a very-long short message.

### BACKGROUND OF THE INVENTION

There may be a need for transmitting a very-long short message in a communication system. For a common short text message, such a very-long short message can be simply divided into a plurality of relatively short messages for transmission. For an Enhanced Messaging Service (EMS) short message, however, information from a sender may fail to be restored if a receiver is incapable of receiving all the divided relatively short messages of the EMS short message and combining them.

A so-called EMS short message is based on a standard short message, but can contain content such as text, animation, picture, sound and the like or a combination thereof.

FIG. 1 illustrates a schematic flow chart of transmitting a very-long short message according to a method in the prior art. In this method, when a sender transmits a very-long short message, if it is determined that the length of the message exceeds a short message length allowed currently, the message is divided into a plurality of independent short messages with lengths within an allowed length range for transmission. At both system side and receiving side, these short messages are also taken as a plurality of independent short messages for processing. For convenient recognition, the sender can add a text identifier at the front or end of the divided short messages to identify a contextual relationship.

As illustrated in FIG. 1, in Step 1, a mobile user enters a short message; when packaging the short message, if a mobile station (an origination A) determines that the length of the short message exceeds a system-allowed range, then the mobile station divides such a very-long short message into a plurality of short messages with lengths within the system-allowed range; when transmitting the short messages, the mobile station sends through a Base Station Controller (BSC) a short message service request for entering a traffic channel.

In Step 2, a serving Mobile Switch Center (MSC) sends an Assignment Request to the BSC for assigning the mobile station to a traffic channel.

In Step 3, the BSC returns an Assignment Complete message to the serving MSC when the traffic channel assignment is completed.

In Step 4, the mobile station transmits each of the divided short messages individually to the serving MSC through an ADDS Deliver message.

In Step 5, the serving MSC transmits that short message to a Message Center (MC). Here, the short message may be transmitted to an origination-side home message center or a destination-side home message center depending on a system configuration. The short message is transmitted to an origination-side home message center as illustrated in FIG. 1.

In Step 6, after receiving the SMDPP message, the origination side-home message center buffers the SMDPP message and returns an smdpp response to the serving MSC.

In Step 7, the origination-side home message center transmits the buffered short message to a destination-side home MC.

In Step 8, after receiving the short message, the destination-side home message center buffers the short message and returns an smdpp response to the origination-side home MC.

In Step 9, the destination-side home message center obtains the SMS address of a destination-side serving MSC (not shown in FIG. 1) and transmits the short message to the destination-side serving MSC.

In Step 10, the destination-side serving MSC initiates a paging and performs a radio channel assignment in the case that it determines a destination user is idle but the short message needs to be transmitted through a traffic channel.

In Step 11, the destination-side serving MSC transmits the short message to the destination side through an ADDS Deliver message.

In Step 12, after receiving the short message, the destination side responds with a Layer-2 response, i.e., an ADDS Deliver Ack message and a Layer-3 response, i.e., an ADDS Deliver [ACK] message.

In Step 13, the destination-side serving MSC releases the radio traffic channel.

Subsequently, Steps 4 to 13 are repeated to complete the transmission of the respective short messages divided from the very-long short message.

It is required in the above implementation in the prior art that the sending side of a short message be capable of dividing a short message, but no requirement is imposed on network side and receiving side. However, the prior art may be disadvantageous in the followings.

It is only applicable to a short text message, that is, it is applicable to the transmission of a very-long short text message, but not applicable to the transmission of a short message containing a binary code stream.

Billing is only enabled for each divided short message, which is rather inflexible (for instance, it cannot enable billing merely for a very-long short message).

After the division into a plurality of short messages, if any of them is transmitted unsuccessfully or is lost, the transmission of the others will not be influenced. Thus, the receiver may receive incomplete information and hence fail to understand the incomplete information.

### SUMMARY OF THE INVENTION

Embodiments of the invention provide a method, device and system for transmitting a very-long short message, which can transmit and receive the very-long short message containing a binary code stream.

According to a first aspect of the invention, there is provided a method for transmitting a very-long short message. The method may include: dividing, by a sender, a very-long short message with a length exceeding a short message length allowed currently into a plurality of messages, and transmitting the plurality of messages, the plurality of messages carrying parameters which indicate that the plurality of messages belong to the same very-long short message; and receiving, by a receiver, the plurality of messages, and combining the plurality of messages into the very-long short message according to the parameters.

According to a second aspect of the invention, there is provided a short message transmitting entity. The short message transmitting entity may include: a determining device adapted to determine whether a length of a very-long short message exceeds a short message length allowed currently; and a transmitting device adapted to, when a determination of the determining device is positive, divide the very-long short message into a plurality of messages and transmit the plurality of messages, the plurality of messages carrying parameters which indicate that the plurality of messages belong to the same very-long short message.

According to a third aspect of the invention, there is provided a short message center. The short message center may include: a receiving device adapted to receive a plurality of messages divided from a very-long short message, wherein the plurality of messages carry parameters which indicate that the plurality of messages belongs to the same very-long short message; a determining device adapted to determine from the parameters whether all the plurality of messages belonging to the same very-long short message have been received; and a forwarding device adapted to forward the plurality of messages when the determining device determines that all the plurality of messages belonging to the same very-long short message has been received.

According to a fourth aspect of the invention, there is provided a short message receiving entity. The short message receiving entity may include: a receiving device adapted to receive a plurality of messages divided from a very-long short message, wherein the plurality of messages carry parameters which indicate that the plurality of messages belong to the same very-long short message; and a combining device adapted to combine the plurality of messages into the very-long short message according to the parameters.

According to a fifth aspect of the invention, there is provided a communication system which may include the above short message transmitting entity and the above short message receiving entity.

The embodiments of the invention may provide a service of transmitting and receiving very-long short message. Due to the parameters indicating that the plurality of messages are divided from the same very-long short message, the receiver can combine the plurality of messages into the very-long short message according to the parameters. In this way, both a very-long short text message and a short message including a binary code stream can be transmitted.

### BRIEF DESCRIPTION OF THE DRAWINGS

FIG. 1 illustrates a schematic flow chart of transmitting a very-long short message in the prior art;

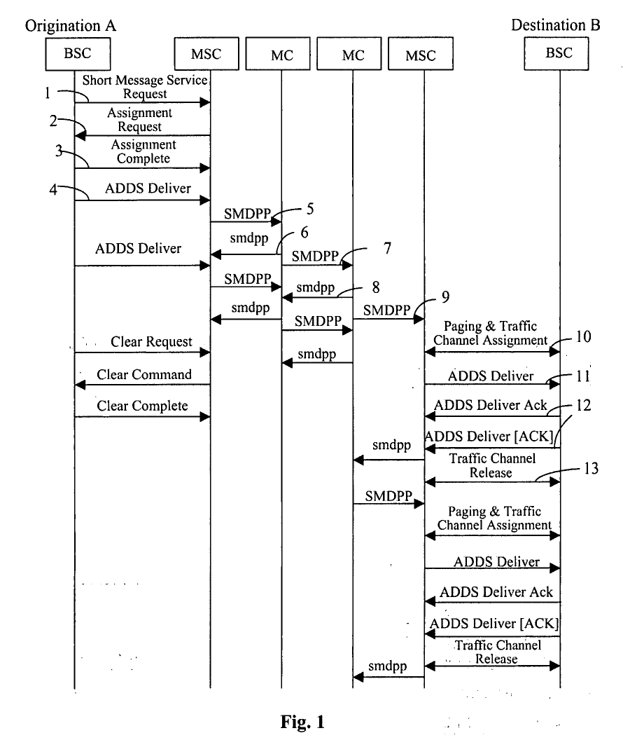

FIG. 2 illustrates a schematic flow chart of transmitting a very-long short message between mobile stations according to an embodiment of the invention;

FIG. 3 illustrates a schematic flow chart of transmitting a very-long short message from a Short Message Entity (SME) to a mobile station according to, an embodiment of the invention;

FIG. 4 illustrates a schematic flow chart of transmitting a very-long short message from a mobile station to an SME according to an embodiment of the invention; and

FIG. 5 is a schematic diagram of a CDMA system according to an embodiment of the invention.

### DETAILED DESCRIPTION OF THE EMBODIMENTS

According to an embodiment of the invention, when a sender determines that the length of a short message exceeds a short message length allowed currently, this message is divided into a plurality of short message for transmission. Fields are added respectively to these short messages to indicate that these short messages belong to the same EMS short message, and that the short messages are respectively start, middle and end parts of the EMS short message. A receiver receives and combines the plurality of short messages belonging to the same EMS short message.

In the embodiment of the invention, the very-long short message is divided into the plurality of short messages for transmission, but these short messages are still treated as a whole at system side. If any of the short messages is transmitted unsuccessfully, the whole EMS short message can be regarded as being transmitted unsuccessfully. Moreover, billing can be enabled flexibly for the short messages.

The principle of the present invention will be described hereunder in detail with an example of CDMA circuit domain.

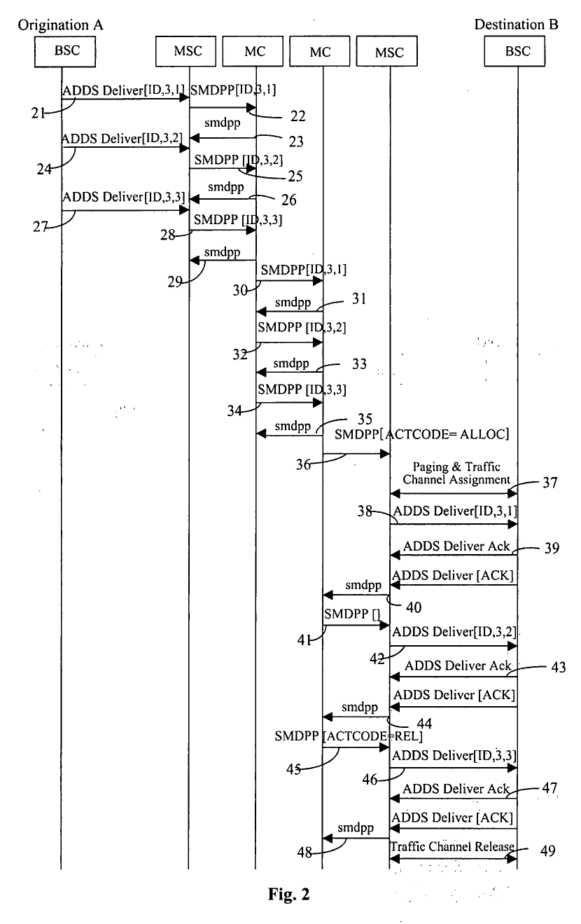

FIG. 2 illustrates a schematic flow chart of transmitting a very-long short message between mobile stations according to an embodiment of the invention.

First, a mobile user enters a short message, and a mobile station (an origination A) packages the short message. If it is determined that the length of the short message exceeds a system-allowed range, such a very-long short message is divided into a plurality of short messages with lengths within the system-allowed range.

After a sender requests for entering a traffic channel, and the assignment of a traffic channel (not shown) is completed, the process goes to Step 21.

As illustrated in FIG. 2, in Step 21, the mobile station assigns the EMS short message with a new EMS identifier (EMS ID) so that the EMS short message may be distinguished from other EMS short messages. The mobile station sequentially fills a short message type of the divided short messages as EMS short message and fills an EMS ID, a total number of the divided short messages and a current message sequence number of the divided short messages, and transmits each of the divided short messages individually to a serving MSC through an ADDS Deliver message.

Here, EMS IDs can be assigned in sequence to avoid repetition. It is needed to ensure that the EMS IDs are not repeated between the same origination A and destination B in a period of time, that is, to ensure the uniqueness of an A+B+EMS ID. For instance, a two-byte field can be assigned as an EMS ID, and this field can be incremented circularly and used as an ID of a new short message. It is obvious to those skilled in the art, that other configuration schemes besides this field configuration scheme can be used for implementing the embodiment of the invention.

In Step 22, the serving MSC determines that a short message is of an EMS short message service type, and transmits the short message to an MC through an SMDPP message.

The short message can be transmitted to an origination-side home message center or a destination-side home message center depending on a system configuration. In this embodiment, the short message is transmitted to an origination-side home message center. The SMDPP message contains a service indicator which indicates that the message is an EMS short message.

In Step 23, the origination-side home message center receives the SMDPP message, and determines that it is of an EMS short message type in accordance with the service indicator.

In the case that the short message is the first one with respect to A+B+EMS ID, which case can be determined according to the EMS short message total number and the sequence number in the short message, the origination-side home message center marks and buffers this short message, and returns an smdpp response to the serving MSC. The marking is intended to indicate an incomplete reception of the whole very-long short message.

In the case that the short message is not the first one and the message center has no corresponding information of the A+B+EMS ID, the origination-side home message center returns an smdpp response indicating a failure; in the case that the short message is the first one and the message center has corresponding information of the A+B+EMS ID, the origination-side home message center determines whether the sequence number in the SMDPP message is consistent with an expected sequence number. If they are not consistent, the origination-side home message center returns an smdpp message indicating a failure.

If they are consistent, the origination-side home message center marks and buffers the short message, and returns an smdpp response indicating a success, and then determines whether the whole very-long short message corresponding to the A+B+EMS ID has been received. If it has not been received completely in a period of time, for example, one day, the origination-side home message center deletes all information corresponding to the A+B+EMS ID.

In Steps 24 to 26 and Steps 27 to 29, the process of Steps 21 to 23 is repeated, until the origination-side home message center receives the whole EMS short message corresponding to the A+B+EMS ID.

In Step 30, the origination-side home message center transmits sequentially the divided short messages of the unique EMS short message corresponding to the A+B+EMS ID to a destination-side home message center.

In Step 31, after receiving an SMDPP message, the destination-side message center performs the same processing as the origination-side home message center does in Step 23.

In Steps 32 to 33 and Steps 34 to 35, the process of Steps 30 to 31 is repeated, until the destination-side home message center receives the whole EMS short message corresponding to the A+B+EMS ID.

Thereafter, the destination-side home message center obtains the SMS address of a destination-side serving MSC (not shown), and transmits sequentially the short messages, each including a service indicator indicating an EMS service, of the unique EMS short message corresponding to the A+B+EMS ID to a destination-side serving MSC. The transmitting in particular includes the following Steps.

In Step 36, the first SMDPP message, which contains ACTCODE indicating Allocation Resources, is transmitted to the destination-side serving MSC.

In Step 37, the destination-side serving MSC determines that the destination side is idle and the ACTCODE is indicative of Allocation Resources, and then initiates a paging and performs an assignment of a radio channel.

In Step 38, the destination-side serving MSC transmits the short message to the destination side through an ADDS Deliver message.

In Step 39, after receiving the short message, the destination-side responds with a Layer-2 response, i.e., an ADDS Deliver Ack message and a Layer-3 response, i.e., an ADDS Deliver [ACK] message.

In Step 40, the destination-side serving MSC sends an smdpp response to the destination-side home message center.

In Step 41, the destination-side home message center transmits sequentially the intermediate short messages, each including a service indicator indicating an EMS service, of the unique EMS short message corresponding to the A+B+EMS ID to the destination-side serving MSC.

In Steps 42 to 44, the destination-side serving MSC performs the same processing as that in Steps 38 to 40.

In Step 45, the destination-side home message center transmits the last SMDPP message corresponding to the EMS ID, and the last SMDPP message contains ACTCODE indicating Release Resources.

In Steps 46 to 48, the destination-side serving MSC performs the same processing as in Steps 38 to 40.

In Step 49, after sending an smdpp response to the destination-side message center, the destination-side serving MSC releases radio resources.

Thereafter, after receiving all the short messages corresponding to the EMS ID, the destination side B combines the short messages into one message.

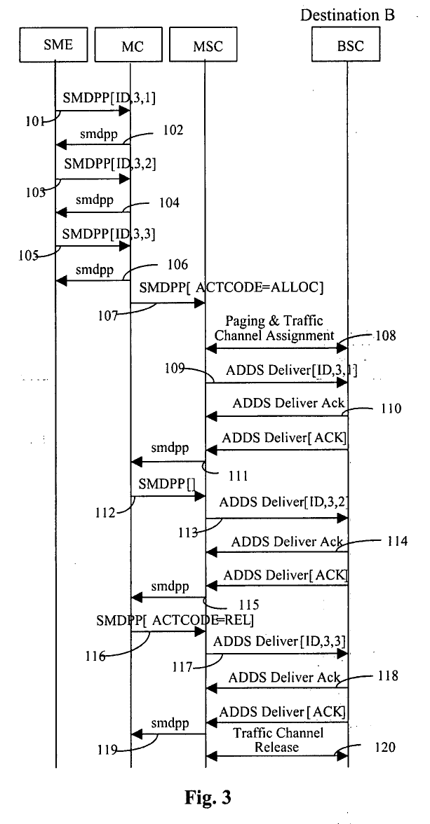

FIG. 3 illustrates a schematic flow chart of transmitting a very-long short message from an SME to a mobile station according to an embodiment of the invention. Here, the SME refers to a short message entity which is a non-mobile station, and can be any network server capable of transmitting a short message, other than a mobile terminal.

The flow illustrated in FIG. 3 is substantially the same as that in FIG. 2 from the origination-side message center to the destination side, that is, the processing of Steps 107 to 120 is substantially the same as that of Steps 36 to 39.

The difference lies in that the SME is used instead of the origination-side MC, that is, Steps 101 to 106 in FIG. 3 are performed between the SME and the destination-side home message center.

It shall be noted that the SME can communicate with the message center through an IP connection besides through ANSI-41.

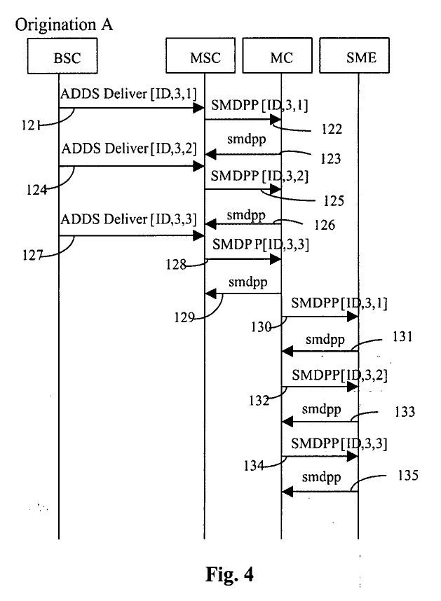

FIG. 4 illustrates a schematic flow chart of transmitting a very-long short message from a mobile station to an SME according to an embodiment of the invention.

The flow illustrated in FIG. 4 is substantially the same as that in FIG. 2 from the origination side to the destination-side message center, that is, the processing of Steps 121 to 129 is substantially the same as that of Steps 21 to 29.

The difference lies in that the SME is used instead of the destination-side MC. That is, Steps 130 to 135 in FIG. 4 are performed between the SME and the origination-side home message center.

It shall be noted that the SME can communicate with the message center through an IP connection besides through ANSI-41.

For convenient understanding, examples will be described in connection with how the messages SMDPP and ADDS generate a service indicator, an EMS ID, a message sequence number and the number of the short messages.

Table 1 illustrates parameters contained in an SMDPP message in the prior art. Parameters such as ServiceIndicator, ACTCODE, etc are contained in the SMDP message.

TABLE 1
Parameters Contained in an SMDPP Message

| SMSDeliveryPointToPoint | | | | |
|---|---|---|---|---|
| INVOKE Parameters | | | Timer: SMT | |
| Field | Value | Type | Reference | Notes |
| Identifier | SET [NATIONAL 18] | M | 520-1.3.2.1 | |
| Length | variable octets | M | 520-1.3.2.1 | |

Contents

| | | | |
|---|---|---|---|
| SMS_BearerData | M | 2.233 | |
| SMS_TeleserviceIdentifier | M | 2.246 | |
| ActionCode | O | 2.2 | j |
| ElectronicSerialNumber | O | 2.112 | a |
| InterMessageTime | O | 2.128 | o |
| MSID | O | 2.153 | a, i, m |
| NewlyAssignedMIN | O | 2.161 | k |
| NewlyAssignedIMSI | O | 2.160 | k |
| NewMINExtension | O | 2.163 | l |
| ServiceIndicator | O | 2.221 | p |
| SMS_ChargeIndicator | O | 2.235 | b |
| SMS_DestinationAddress | O | 2.236 | c |
| SMS_MessageCount | O | 2.237 | d |
| SMS_NotificationIndicator | O | 2.239 | e |
| SMS_OriginalDestinationAddress | O | 2.240 | f |
| SMS_OriginalDestinationSubaddress | O | 2.241 | g |
| SMS_OriginalOriginatingAddress | O | 2.242 | h |
| SMS_OriginalOriginatingSubaddress | O | 2.243 | g |
| SMS_OriginatingAddress | O | 2.244 | c |
| TemporaryReferenceNumber | O | 2.277 | n |

For the ActionCode, 16 indicates Release Resources, 18 indicates Allocate Resources, as specified in the prior art, and there is no need to be extended.

According to an embodiment of the invention, the ServiceIndicator in the SMDPP message can be extended to indicate an EMS short message.

TABLE 2
Parameters Contained in an SMDPP Message

| Field | Value | Type | Reference | Notes |
|---|---|---|---|---|
| Identifier | ServiceIndicator | M | Part 550 | |
| | IMPLICIT OCTET STRING | | Section 1.2 | |
| Length | variable octets | M | Part 550 | |
| | | | Section 1.1 | |

Contents

| | | | | | | | | | |
|---|---|---|---|---|---|---|---|---|---|
| H | G | F | E | D | C | B | A | Octet | Notes |

| | | |
|---|---|---|
| Service | 1 | |
| . . . | n | a |

Notes:
a. Ignore extra octets, if received. Send only defined (or significant) octets.

Service (octet 1)

| Value | Meaning |
|---|---|
| 0 | Undefined Service. |
| 1 | CDMA OTASP Service. |
| 2 | TDMA OTASP Service. |
| 3 | CDMA OTAPA Service. |
| 4 through 223 | Reserved. Treat the same as value 0, |
| | Undefined Service |
| 224 through 255 | Reserved for TIA-41 protocol extension. If unknown, |
| | treat the same as value 0, Undefined Service |

The ServiceIndicator can indicate an EMS service with a value of 8.

The parameters including the EMS ID, the sequence number, and the number of the short messages transported in the SMDPP message, can be contained in a parameter SMS_BearerData.

According to an embodiment of the invention, for the ADDS Deliver message, an SMS transport-layer message can be extended to indicate an EMS service. Table 3 is an example of extending the SMS transport-layer message to indicate EMS.

TABLE 3
SMS Transport-layer Message

| | base -> | mobile -> | |
|---|---|---|---|
| Message Type | mobile | base | SMS_MSG_TYPE |
| SMS Point-to-Point | X | X | [00000000] |
| SMS Broadcast | X | | [00000001] |
| SMS Acknowledge | X | X | [00000010] |
| EMS Point-to-Point | X | X | [00000011] |

All other values are reserved.

Additionally, definitions of respective message parameters of the EMS can be added to the extended SMS transport-layer message, as illustrated in Tables 4 to 7.

TABLE 4
BearerData Subparameter Identifiers

| | | | |
|---|---|---|---|
| SMS_DestinationAddress | O | 2.236 | c |
| SMS_MessageCount | O | 2.237 | d |
| SMS_NotificationIndicator | O | 2.239 | e |
| SMS_OriginalDestinationAddress | O | 2.240 | f |
| SMS_OriginalDestinationSubaddress | O | 2.241 | g |
| SMS_OriginalOriginatingAddress | O | 2.242 | h |
| SMS_OriginalOriginatingSubaddress | O | 2.243 | g |
| SMS_OriginatingAddress | O | 2.244 | c |
| TemporaryReferenceNumber | O | 2.277 | n |

TABLE 5
Message Element EMS ID

| Field | Length (bits) |
|---|---|
| SUBPARAMETER_ID | 8 |
| SUBPARAM_LEN | 8 |
| EMS ID | 16 |

TABLE 6
Message Element EMS Number (message sequence number)

| Field | Length (bits) |
|---|---|
| SUBPARAMETER_ID | 8 |
| SUBPARAM_LEN | 8 |
| EMS_MSG_NUM | 8 |

TABLE 7
Message Element Number of the EMS
Messages (total message number)

| Field | Length (bits) |
|---|---|
| SUBPARAMETER_ID | 8 |
| SUBPARAM_LEN | 8 |
| NUM_EMS_MSG | 8 |

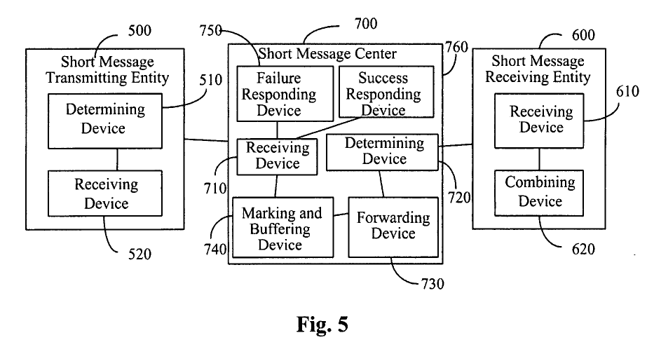

FIG. 5 is a schematic diagram of a CDMA system according to an embodiment of the invention.

The CDMA system according to the embodiment of the invention includes a short message transmitting entity 500 and a short message receiving entity 600. The short message transmitting entity 500 is adapted to divide a very-long short message with a length exceeding a currently allowed short message length into a plurality of messages. The plurality of messages carry parameters which indicate that the messages belong to the same very-long short message. The short message receiving entity 600 is adapted to receive the plurality of messages and combine them into the very-long short message according to those parameters.

In another embodiment of the invention, there may be an intermediate device for forwarding a short message between the short message transmitting entity 500 and the short message receiving entity 600.

In a specific embodiment of the invention, there may be a short message center 700 between the short message transmitting entity 500 and the short message receiving entity 600. The short message center 700 is adapted to receive the plurality of short messages, and forwards the plurality of short messages after it is determined according to the parameters carried in the short messages that all the plurality of short messages have been received.

Here, the short message transmitting entity 500 may be a terminal device such as a mobile station, and the like; the short message receiving entity 600 may also be a terminal device such as a mobile station. The short message center 700 may be an origination-side short message center or a destination-side short message center. Additionally, the short message center 700 can interact with the SME (not shown) to transmit a short message from the mobile station to the SME or from the SME to the mobile station. It shall be noted that the SME may communicate with the short message center 700 through an IP connection besides through ANSI-41.

Furthermore, the embodiment of the transmission of a short message in the CDMA system may involve the participation of a serving MSC and a destination-side serving MSC.

In an embodiment of the invention, the short message transmitting entity in the CDMA system includes the following devices.

A determining device 510 is adapted to determine whether the length of a very-long short message exceeds a short message length allowed currently.

A transmitting device 520 is adapted to, upon a positive determination of the determining device 501, divide the very-long short message into a plurality of short messages for transmission. The plurality of short messages carry parameters which indicate that the short messages belong to the same very-long short message.

Here, the transmitting device 520 may be an ADDS Deliver message transmitting device, and the parameters include a service indicator indicating a very-long short message service, an ID of the very-long short message, a total number of the plurality of short messages, and a sequence number of a current short message. Particularly, for an ADDS Deliver message, an SMS transport-layer message can be extended to indicate an EMS service, as illustrated in Table 3 by way of an example. Moreover, definitions of respective message parameters of the EMS can be added to the extended SMS transport-layer message, as illustrated in Tables 4 to 7 by way of an example.

In an embodiment of the invention, the short message center in the CDMA system includes the following devices.

A receiving device 710 is adapted to receive a plurality of short messages divided from a very-long short message, and the plurality of short messages carry parameters indicating that the short messages belong to the same very-long short message.

A determining device 720 is adapted to determine from the parameters whether all the plurality of short messages belonging to the same very-long short message have been received.

A forwarding device 730 is adapted to forward the plurality of short messages after the determining device determines that all the plurality of short messages belonging to the same very-long short message have been received.

In an embodiment of the invention, the short message center may further include the following devices.

A marking and buffering device 740 is adapted to mark and buffer a short message received by the short message center 700 when the message is the first one with respect to the very-long short message.

A failure responding device 750 is adapted to return a failure response, when a short message received by the short message center 700 is not the first one with respect to the very-long short message, and there exists at the short message center 700 no message belonging to the same very-long short message to which the received message belongs or the received message is not in an expected sequence.

A success responding device 760 is adapted to return a success response, when a short message received by the short message center 700 is not the first one with respect to the very-long short message, and there exists at the short message center 700 a short message belonging to the same very-long short message to which the received message belongs and the received message is in an expected sequence.

Here, whether the received message is the first one, whether there exists a short message belonging to the same very-long short message as the received message belongs to and whether the received message is in an expected sequence can be determined from the parameters such as the ID of the very-long short message, a total number of the plurality of short messages and the sequence number of a current short message.

In an embodiment of the invention, the short message receiving entity in the CDMA system includes the following devices. A receiving device 610 is adapted to receive a plurality of short messages divided from a very-long short message, and the plurality of short messages carry parameters indicating that the short messages belong to the same very-long short message;

A combining device 620 is adapted to combine the plurality of short messages into the very-long short message according to the parameters.

Here, the receiving device 610 may be an ADDS Deliver message receiving device, and the parameters include a service indicator indicating a very-long short message service, an identifier (ID) of the very-long short message, a total number of the plurality of short messages, and a sequence number of a current short message.

For the combination, the plurality of short messages with the same very-long short message ID are arranged in accordance with the sequence numbers of the messages, and the total number of the short messages is equal to that of the plurality of short messages carried in the very-long short message.

Here, for an ADDS Deliver message, an SMS transport-layer message can be extended to indicate an EMS service, as illustrated in Table 3 by way of an example. Moreover, definitions of respective message parameters of the EMS can be added to the extended SMS transport-layer message, as illustrated in Tables 4 to 7 by way of an example.

In an embodiment of the invention, a service of transmitting and receiving a very-long EMS short message can be provided. In addition to this, a service of transmitting a multimedia short message, for example, MMS can be provided in another embodiment of the invention.

It shall be appreciated by those skilled in the art that the invention can be applied in a case where a service controlling point transmits a short message directly instead of through an MC, for instance, in a case where a Position Determination Entity (PDE) sends an SMDPP message to a serving MSC directly instead of through an MC, and a case where an Over-the-Air Service Provisioning Function (OTAF) sends an SMDPP message to a serving MSC directly instead of through an MC, etc.

Furthermore, when any one of the divided short messages is transmitted unsuccessfully or lost, the transmission of the other short messages will be influenced, so that the integrity of information received by the receiver can be ensured. Moreover, the billing can be enabled only for the single very-long short message, which is flexibly.

Although the present invention has been described above with an example of CDMA circuit domain, it should be noted that it should not be limited to the CDMA circuit domain and also is applicable to other domains such as GSM circuit domain.

Obviously, various modifications can be made to the embodiments of the invention described here without departing from the spirit and scope of the present invention. Therefore, all the modifications obvious to those skilled in the art shall be embraced within the scope of the invention as defined in the accompanying claims.

What is claimed is:

1. A method for transmitting a very-long short message, comprising: dividing, by a sender, a very-long short message with a length exceeding a short message length allowed currently into a plurality of messages, and transmitting the plurality of messages, the plurality of messages carrying parameters which indicate that the plurality of messages belong to the same very-long short message; and
receiving, by a receiver, the plurality of messages, and combining the plurality of messages into the very-long short message according to the parameters.

2. The method according to claim 1, wherein after the step of transmitting the plurality of messages and before the step of receiving the plurality of messages, the method further comprises: receiving, by a short message center, the plurality of messages, and forwarding the plurality of messages after it is determined according to the parameters that all the plurality of messages have been received.

3. The method according to claim 2, wherein the method further comprises: when it is determined that a short message received by the short-message center is the first one with respect to the very-long short message, marking and buffering, by the short message center, the short message.

4. The method according to claim 3, wherein the method further comprises: when it is determined that the short message received by the short message center is not the first one with respect to the very-long short message and that there exists no message belonging to the same very-long short message as the received message belongs to at the short message center or the received message is in a sequence inconsistent with an expected sequence, returning, by the short message center, a failure response.

5. The method according to claim 4, further comprising: when it is determined that the short message received by the short message center is not the first one with respect to the very-long short message and that there exists a message belonging to the same very-long short message as the received message belongs to at the short message center and the received message is in a sequence consistent with the expected sequence, marking and buffering, by the short message center, the received message and returning a success response.

6. The method according to any one of claims 1, wherein one of the sender and the receiver is a mobile station, and the other of the sender and the receiver is a short message entity other than a mobile station.

7. The method according to any one of claims 1, wherein both the sender and the receiver are mobile stations or short message entities other than a mobile station.

8. The method according to claim 1, wherein the parameters comprise a service indicator indicating a very-long short message service, an identifier of the very-long short message, a total number of the plurality of messages and a current message sequence number.

9. The method according to claims 2, wherein the parameters comprise a service indicator indicating a very-long short message service, an identifier of the very-long short message, a total number of the plurality of messages and a current message sequence number.

10. The method according to claim 9, wherein when the short message center receives and forwards a message, the service indicator is extended to indicate a very-long short message service.

11. The method according to claim 10, wherein when the short message center receives and forwards a message, a parameter SMS_Bearer Data is used to carry the service indicator indicating the very-long short message service, the current message sequence number and the total number of the plurality of messages.

12. The method according to claim 9, wherein when the sender transmits a message, a Short Message Service (SMS) transport-layer message is extended to indicate a very-long short message service.

13. The method according to claim 1, wherein the very-long short message is an enhanced message or a multimedia short message.

14. A short message transmitting entity, comprising:
a determining device adapted to determine whether a length of a very-long short message exceeds a short message length allowed currently; and
a transmitting device adapted to, when a determination of the determining device is positive, divide the very-long short message into a plurality of messages and transmit the plurality of messages, the plurality of messages carrying parameters which indicate that the plurality of messages belong to the same very-long short message.

15. The short message transmitting entity according to claim 14, wherein the transmitting device is an ADDS Deliver message transmitting device, and the parameters comprise a service indicator indicating the very-long short message service, an identifier of the very-long short message, a total number of the plurality of messages and a current message sequence number.

16. A short message center, comprising:
a receiving device adapted to receive a plurality 6f messages divided from a very-long short message, wherein the plurality of messages carry parameters which indicate that the plurality of messages belongs to the same very-long short message;
a determining device adapted to determine from the parameters whether all the plurality of messages belonging to the same very-long short message have been received; and
a forwarding device adapted to forward the plurality of messages when the determining device determines that all the plurality of messages belonging to the same very-long short message has been received.

17. The short message center according to claim 16, further comprising:
a marking and buffering device adapted to mark and buffer a message received by the short message center in the case that the message is the, first one with respect to the very-long short message.

18. The short message center according to claim 17, further comprising:
a failure responding device adapted to return a failure response in the case that the short message received by the short message center is not the first one with respect to the very-long short message and that there exists no message belonging, to the same very-long short message as the received message belongs to at the short message center or the received message is in a sequence inconsistent with an expected sequence.

19. The short message center according to claim 18, further comprising:
a success responding device adapted to return a success response in the case that the short message received by the short message center is not the first one with respect to the very-long short message and that there exists a message belonging to the same very-long short message as the received message belongs to at the short message center and the received message is in a sequence consistent with the expected sequence.

20. A short message receiving entity, comprising:
a receiving device adapted to receive a plurality of messages divided from a very-long short message, wherein the plurality of messages carry parameters which indicate that the plurality of messages belong to the same very-long short message; and
a combining device adapted to combine the plurality of messages into the very-long short message according to the parameters.

21. The short message receiving entity according to claim 20, wherein the receiving device is an ADDS Deliver message receiving device, and the parameters comprise a service indicator indicating a very-long short message service, an identifier of the very-long short message, a total number of the plurality of messages and a current message sequence number.

22. A communication system, comprising:
a short message transmitting entity adapted to divide a very-long short message with a length exceeding a short message length allowed currently into a plurality of messages and transmit the plurality of messages, wherein the plurality of messages carry parameters which indicate that the plurality of message belongs to the same very-long short message; and
a short message receiving entity adapted to receive the plurality of messages, and combine the plurality of messages into the very-long short message, according to the parameters.

23. The communication system according to claim 22, further comprising:
a short message center adapted to receive the plurality of messages, and forward the plurality of messages after it is determined from the parameters that all the plurality of messages have been received.
